(19) United States
(12) Patent Application Publication
(10) Pub. No.: US 2007/0018473 A1
(43) Pub. Date: Jan. 25, 2007

(54) Loading space system for motor vehicles

(75) Inventors: Rolf Alliger, Weil der Stadt (DE); Juergen Hirsch, Schorndorf (DE); Thomas Neff, Leinfelden-Echterdingen (DE); Holger Schleife, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/563,766

(22) PCT Filed: Jun. 30, 2004
(86) PCT No.: PCT/EP04/07070

§ 371 Date: Jun. 29, 2006

(30) Foreign Application Priority Data
Jul. 9, 2003 (DE) 103 30 887.3

(51) Int. Cl. B60R 27/00

(52) U.S. Cl. 296/24.4

(57) ABSTRACT

A cover element for motor vehicles, with two longitudinal sides and two transverse sides running transversely thereto, and at least one first pivot hinge. The cover element can be connected at least over part of the longitudinal sides to a first bearing in the region of the vehicle side wall approximately parallel to a vehicle floor, the first pivot hinge, which is arranged parallel to the transverse side, dividing the cover element into a first cover part and a second cover part. At least the first cover part can be connected to the vehicle side wall via a second bearing and/or to the vehicle floor via a third bearing and can be fixed approximately at right angles to the vehicle floor within the loading space. In this case, the second cover part can be pivoted from the front to the rear through 180° between two horizontal positions.

### CROSS-REFERENCE TO RELATED APPLICATIONS

This is a U.S. National Phase of International Application No. PCT/EP2004/007070, filed Jun. 30, 2004, and claims the benefit of priority under 35 U.S.C. §119 based on DE 103 30 887.3, filed Jul. 9, 2003, the entire disclosures of which are incorporated herein by reference.

### BACKGROUND AND SUMMARY OF THE INVENTION

The invention relates to a loading space system for motor vehicles with a cover element which runs parallel to a vehicle longitudinal axis and has two longitudinal sides, two transverse sides running transversely thereto and at least one first pivot hinge, and which can be connected at least over part of the longitudinal sides to a first bearing running approximately parallel to a motor vehicle floor in the region of a motor vehicle side wall, the first pivot hinge being arranged parallel to the transverse side, and the cover element being divided into a first cover part and a second cover part.

German Patent Document 84 02 098.9 U1 has already disclosed a loading space covering which is formed from three foldably connected parts. In this case, the loading space covering is placed with its entire surface area approximately parallel to the loading space floor onto supporting profiles provided for it in the lateral region of the loading space, or the parts are folded forward onto one another correspondingly parallel to the loading space floor.

The invention is based on the object of designing and arranging a loading space with a cover element in such a manner that a flexible loading space design is ensured.

The object is achieved according to the invention by the fact that at least the first cover part can be connected approximately at right angles to the motor vehicle floor to a motor vehicle side wall via a second bearing and/or to the motor vehicle floor via a third bearing. The effect achieved by this is that, in addition to the horizontal covering, the loading space may also be divided or partitioned off with respect to the vehicle longitudinal axis.

For this purpose, it is advantageous that the first cover part can be pivoted relative to the second cover part, irrespective of the position thereof, through at least 180°, in particular through 270° or through 360°, between a first position A and a second position B. The two loading space parts formed by the cover part arranged at right angles to the vehicle floor can therefore be partitioned off upward by the cover part not arranged at right angles. In addition, access to the loading space from the vehicle seat is ensured.

An additional possibility, according to a development, is for at least one cover part to have at least one second pivot hinge which is arranged parallel to the first pivot hinge and divides the cover part into at least a first cover piece and a second cover piece. The division of the cover parts into at least two cover pieces ensures the handling, in particular with regard to the fastening to the third bearing arranged at right angles to the vehicle floor. The cover element formed in this manner can therefore be folded over and pivoted into the desired position in the manner of segments by actuation of the particular pivot hinges.

Furthermore, it is advantageous that the cover pieces can be pivoted relative to each other through at least 180°, in particular 360°, via the second pivot hinge. The various cover pieces can therefore be brought to bear against one another so that the entire surface of the cover element is reduced in the desired manner.

It is also advantageous for this that the first and/or the second cover part is/are connected releaseably to a fourth bearing in the region of a vehicle seat wall. The use of a fourth bearing in the region of the vehicle seat wall ensures that a mechanical coupling of the cover element to the tailgate will be strong. With the opening of the tailgate, the cover element is at least partially raised, at least in the region of the tailgate, by corresponding tensioning means, so that a slipping of the put-away element due to the action of the tensioning means of the tailgate is prevented by the bearing in the region of the rear seat wall.

According to a preferred embodiment of the solution according to the invention, provision is finally made for the first and/or the second cover part to be connectable to a fifth bearing in the region of a vehicle tailgate. The guiding or the bearing of the cover element in the region of the tailgate ensures an optimum fit during operation.

For the present invention, it is of particular importance that the bearings are designed as supported bearings, sliding-fit bearings and/or clamping-fit bearings. In this case, the supported bearing is designed as a step within the motor vehicle side wall, with the sliding-fit bearing being designed as a depression or groove within the motor vehicle side wall or within the motor vehicle floor. The various bearings may optionally have spring means or pivot means which ensure that the cover element is clamped or locked in the respective bearing.

In conjunction with the design and arrangement according to the invention, it is advantageous that the second bearing is arranged approximately centrally between the vehicle seat wall and the vehicle tailgate in the direction of the vehicle longitudinal axis and/or, starting from this central position, is arranged in a manner such that it can be offset in the longitudinal direction with respect to the length of the cover piece. The use of further bearings arranged vertically to the vehicle floor ensures a variable division of the loading space with respect to the motor vehicle longitudinal axis.

It is advantageous, furthermore, that the cover element in the region of the motor vehicle floor and/or in the region of the vehicle seat wall can be placed such that it is approximately parallel and at least partially rests on them. The cover element can therefore be placed in the region of the vehicle seat wall or in the region of the motor vehicle floor, with the result that the entire loading space can be used.

In addition, it is advantageous that the cover element can be connected in the region of the longitudinal sides and the transverse sides to the particular bearing. The connectability of the put-away element in the region of the longitudinal sides and transverse sides ensures that the available loading space is used in every position of the cover element.

Furthermore, it is advantageous that the second foldable cover part is connected pivotably to the first foldable cover part and can be pivoted with respect to the motor vehicle floor into a vertical position and can be fixed there in the region of the motor vehicle floor and/or in the region of the motor vehicle side wall.

In addition to the right-angled arrangement of the cover element with respect to the motor vehicle floor, other angle dimensions differing therefrom are also provided, so that that part of the loading space which is to be partitioned off can be formed in accordance with the items to be loaded. In this case, it is possible, on the one hand, to provide correspondingly arranged bearings in the region of the side wall or to design these bearings or the second bearing in the region of the motor vehicle side wall in an adjustable or pivotable manner.

Other objects, advantages, and novel features of the present invention will become apparent from the following detailed description of the invention when considered in conjunction with the accompanying drawings, for example.

### BRIEF DESCRIPTION OF THE DRAWINGS

FIG. 1 shows a schematic diagram of a cover element in accordance with an embodiment of the present invention in a horizontal position;

FIG. 2 shows a schematic diagram of the cover element of FIG. 1 with a pivoted part;

FIG. 3 shows a schematic diagram of the cover element of FIG. 1 with a partially folded part;

FIG. 4 shows a schematic diagram of the cover element of FIG. 1 with a vertically arranged part;

FIG. 5 shows a schematic diagram of the cover element of FIG. 1 with a vertically arranged part in a pivoted position;

FIG. 6 shows a schematic diagram of the cover element of FIG. 1 with a vertically arranged part in a pivoted position.

### DETAILED DESCRIPTION

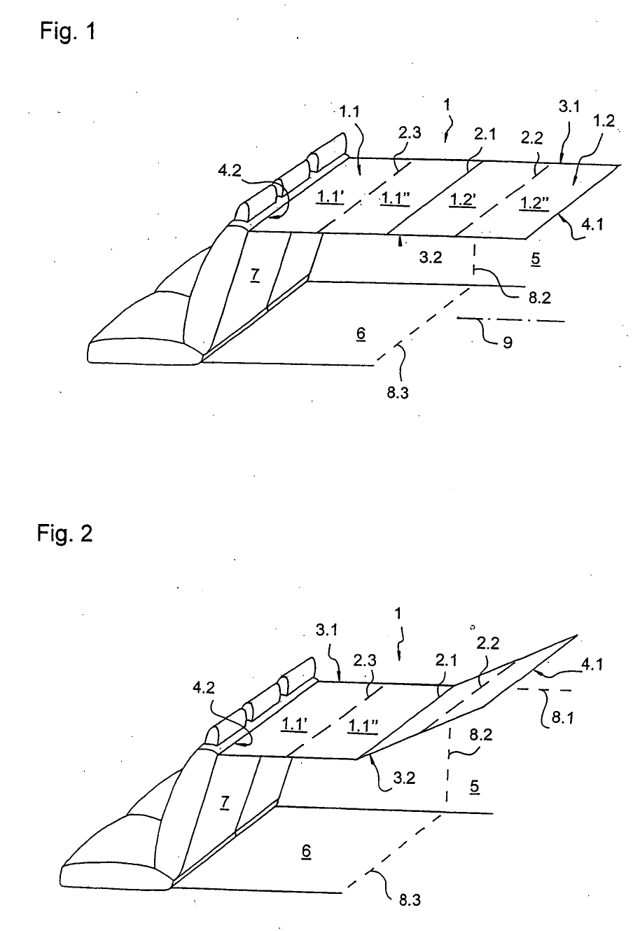

A cover element 1 illustrated in FIG. 1 is arranged adjoining a vehicle seat wall 7 of a vehicle seat row in a loading space of a passenger vehicle (not illustrated specifically). In this case, the loading space is bounded by a motor vehicle floor 6 and a motor vehicle side wall 5 and runs, corresponding to a vehicle longitudinal axis 9, from the vehicle seat wall 7 toward the rear or tailgate (not illustrated specifically).

The cover element 1 here is of essentially rectangular design and has a first longitudinal side 3.1, a second longitudinal side 3.2 and a first and second transverse side 4.1, 4.2. The two longitudinal sides 3.1, 3.2 and the two transverse sides 4.1, 4.2 are in each case arranged parallel to one another.

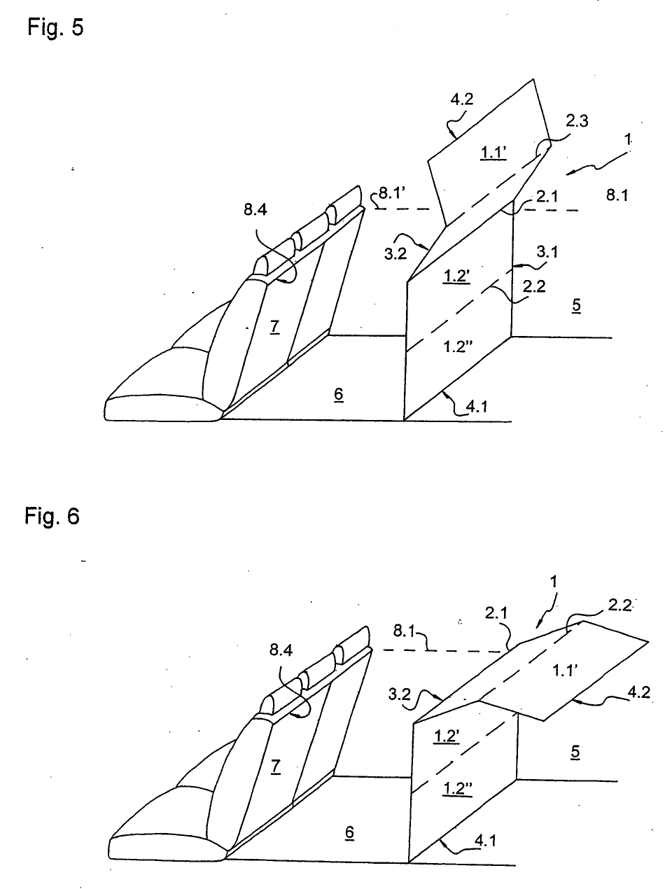

The cover element 1 is fastened in the region of the vehicle side wall 5 via a first bearing 8.1 according to FIG. 2 and therefore rests next to this first bearing 8.1 and the corresponding bearing (not illustrated in the figures) of the opposite side wall (not illustrated). In addition, the cover element 1 is fastened in the region of the vehicle seat wall 7 via a fourth bearing 8.4 according to FIG. 5 to the latter by the transverse side 4.2.

In addition, the cover element 1 has a first pivot hinge 2.1 which divides the cover element 1 into a first cover part 1.1 and a second cover part 1.2. The two cover parts 1.1 and 1.2 are therefore connected pivotably to each other and, according to the following exemplary embodiments, can be pivoted independently of each other between the various horizontal and vertical positions.

In addition to this first pivot hinge 2.1, each cover part 1.1, 1.2 has a second or third pivot hinge 2.2, 2.3 which divides the particular cover part 1.1, 1.2 into a first and second cover piece 1.1′, 1.1″ and 1.2′ and 1.2″.

According to FIG. 2, the first cover part 1.1 rests with the longitudinal side 3.1 on the first bearing 8.1 and is fastened in the region of the transverse side 4.2 to the vehicle seat wall 7 by the fourth bearing 8.4 (not illustrated specifically). In this case, the second cover part 1.2 is pivoted, starting from the horizontal position, upward and forward relative to the first cover part 1.1.

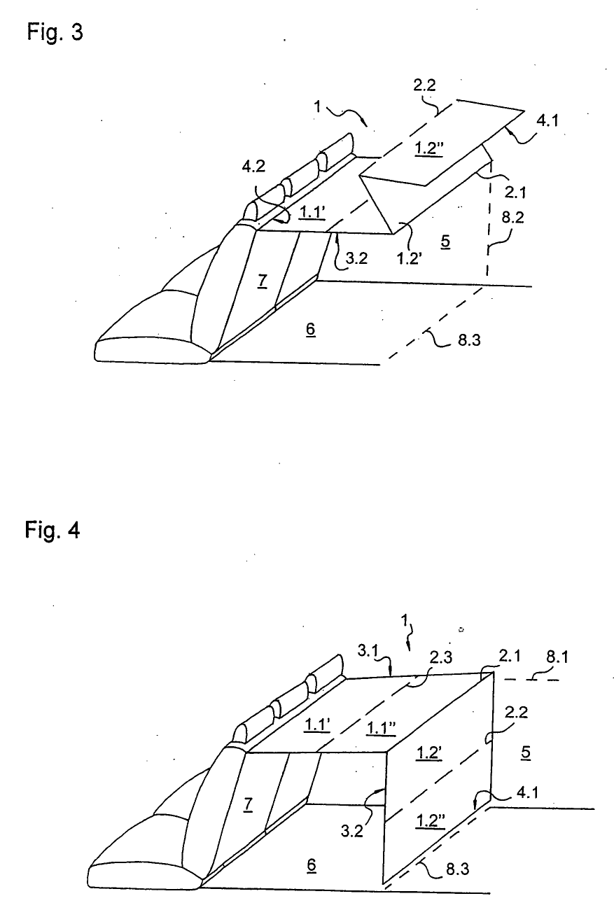

According to FIG. 3, the second cover part 1.2 is pivoted, starting from FIG. 1, forward through a further angle segment about the first pivot hinge 2.1. At the same time, the first cover piece 1.2′ is pivoted relative to the second cover piece 1.2″ of the second cover part 1.2 about the second pivot hinge 2.2 in such a manner that both undersides of the cover pieces 1.2′, 1.2″ according to FIG. 2 come to bear against each other.

In the region of the motor vehicle side wall 5, there is provided next to the first bearing 8.1, 8.1′ a second bearing 8.2 which is arranged at right angles to the motor vehicle floor 6 and is intended for receiving the cover element 1 or cover part 1.2. In addition, a third bearing 8.3 is provided in the region of the motor vehicle floor 6 at right angles to the motor vehicle side wall 5.

According to FIG. 4, the second cover part 1.2 is oriented vertically downward, at right angles to the motor vehicle floor 6. The second cover part 1.2 is arranged here with the longitudinal side 3.1 on the second bearing 8.2 and with the transverse side 4.1 in the region of the third bearing 8.3 or can be connected to the third bearing 8.3. The cover element 1 formed in this manner partitions off the available loading space according to FIG. 4 in the region behind the motor vehicle seat wall 7 in the manner of a box. In this case, the second bearing 8.2 is designed as a sliding bearing, with the third bearing 8.3 likewise having a slot shape (not illustrated specifically) for the admission of the transverse side 4.1.

According to FIG. 5, the first cover part 1.1, starting from FIG. 4, is released from the fourth bearing 8.4 and is at least partially pivoted to the rear about the first pivot hinge 2.1. The second cover part 1.2 remains standing in the vertical position.

According to FIG. 6, the loading space is partitioned off in the rear region in the longitudinal direction by means of the second cover part 1.2, which is arranged vertically to the motor vehicle floor 6, and upward by means of the horizontally arranged, first cover part 1.1. Pivoting of the respective cover pieces 1.1′, 1.1″ and folding them over enables the relevant cover part 1.1 to be reduced in its size.

In an exemplary embodiment (not illustrated), a plurality of vertically arranged bearings 8.1-8.4 are provided in accordance with the longitudinal directional or vehicle longitudinal axis 9, with the result that the respective cover part 1.1, 1.2 can be fastened in various positions with respect to the vehicle longitudinal axis 9.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1-11. (canceled)

12. A loading space system for motor vehicles, comprising:
a cover element arranged to be located in a vehicle parallel to a vehicle longitudinal axis, the cover element having two longitudinal sides and two transverse sides and including a first cover part and a second cover part, the first cover part being in front with respect to the vehicle longitudinal axis of the second cover part;
a first pivot hinge connecting the first cover part and the second cover part, the first pivot hinge arranged parallel to the transverse sides and connectable to a first bearing which runs approximately parallel to a motor vehicle floor in the region of a motor vehicle side wall,
wherein at least the second cover part is connectable to at least one of a second bearing at the vehicle side wall at approximately right angles to the motor vehicle floor and a third bearing at the motor vehicle floor.

13. The loading space system as claimed in claim 12, wherein the first cover part is pivotable relative to the second cover part through at least 180° between a first position and a second position, without regard to the position of the second cover part.

14. The loading space system as claimed in claim 12, wherein at least one cover part has at least one second pivot hinge arranged parallel to the first pivot hinge, the second pivot hinge dividing its cover part into at least a first cover piece and a second cover piece.

15. The loading space system as claimed in claim 13, wherein at least one cover part has at least one second pivot hinge arranged parallel to the first pivot hinge, the second pivot hinge dividing its cover part into at least a first cover piece and a second cover piece.

16. The loading space system as claimed in claim 14, wherein the cover pieces can be pivoted relative to each other through at least 180°.

17. The loading space system as claimed in claim 15, wherein the cover pieces can be pivoted relative to each other through at least 180°.

18. The loading space system as claimed in claim 12, wherein at least one of the first cover part and the second cover part is arranged to be releasably connected to a fourth bearing in the region of a vehicle seat wall.

19. The loading space system as claimed in claim 12, wherein at least one of the first cover part and the second cover part is arranged to be connected to a fifth bearing in a region of a vehicle tailgate.

20. The loading space system as claimed in claim 18, wherein at least one of the first cover part and the second cover part is arranged to be connected to a fifth bearing in a region of a vehicle tailgate.

21. The loading space system as claimed in claim 12, wherein the bearings are at least one of supporting bearings, sliding-fit bearings and clamping-fit bearings.

22. The loading space system as claimed in claim 12, wherein the second bearing is arranged approximately centrally between a vehicle seat wall and a vehicle tailgate in the direction of the vehicle longitudinal axis

23. The loading space system as claimed in claim 22, wherein the second bearing is arranged to be offset in the longitudinal direction.

24. The loading space system as claimed in claim 12, wherein the cover element in the region of at least one of the motor vehicle floor and a vehicle seat wall is locatable such that the cover element is approximately parallel to, and at least partially rests on, at least one of the vehicle floor and the vehicle seat wall.

25. The loading space system as claimed in claim 12, wherein the cover element is connectable to at least one of the bearings in at least one region of the longitudinal sides and the transverse sides.

26. The loading space system as claimed in claim 12, wherein the second cover part
is connected pivotably to the first cover part,
is pivotable into a vertical position with respect to the motor vehicle floor, and
is fixable in at least one of a region of the motor vehicle floor and a region of the motor vehicle side wall.
